(19) United States
(12) Patent Application Publication
(10) Pub. No.: US 2005/0113471 A1
(43) Pub. Date: May 26, 2005

(54) Modeling compound and method of making a modeling compound

(76) Inventors: Jorge Sanchez, Chicago, IL (US); Ferdinand Polido, Carol Stream, IL (US)

Correspondence Address: Todd S. Parkhurst, 30th Floor, 131 South Dearborn St., Chicago, IL, 60603, US

(21) Appl. No.: 10/721,617

(22) Filed: Nov. 25, 2003

(51) Int. Cl. C08J 9/00

(52) U.S. Cl. 521/50

(57) ABSTRACT

The present invention is directed to low density modeling compounds which comprise little or no water and which overcome or at least substantially reduce problems associated with existing modeling compounds and modeling doughs. The preferred exemplary embodiment of the present invention comprises polyvinyl chloride resin, primary plasticizer, secondary plasticizer, stabilizer, microspheres, and a thixotropic agent. The modeling compound of the present invention comprises 0.3% or less water by weight of the compound.

### BACKGROUND OF THE INVENTION

1. Field of the Invention

The present invention relates, in general, to the field of modeling compounds. More specifically, the present invention is directed to low density modeling compounds which comprise little or no water.

2. Description of the Related Art

The present invention overcomes the shortcomings and the deficiencies of the prior art and is directed to low density modeling compounds which solve or at least substantially reduce the impact of these problems associated with existing modeling compounds.

Several modeling compounds and more specifically modeling doughs are currently available. Many oil-based clays such as naturally occurring clays as well as man-made, water-based modeling doughs are commonly found in the market. Existing water-based doughs typically comprise 4% to 15% polyvinyl alcohol, 40% to 80% water, gellant, and filler material. These doughs are not only used by children as a toy but are also used by artists to form sculptures and bases in other types of artwork. They are easily molded into various shapes and retain their shape for as long as desired. However, such conventional modeling compounds and doughs are deficient in several ways.

Conventional modeling doughs contain a significant amount of water by weight. As a result, they exhibit several undesirable and disadvantageous characteristics. First, the plasticity of the dough is highly dependent on the temperature. Increased temperatures cause the water to evaporate and reduce the plasticity of the compound. Additionally, mere nonuse of the dough for a long period of time also dries the dough and reduces its plasticity. This is disadvantageous because it significantly reduces the shelf life of the product. Moreover, it becomes useless as a toy because it can no longer be easily molded into various shapes. Furthermore, it precludes an artist from starting a project and waiting a significant amount of time before finishing it. For example, an artist cannot work slowly on different pieces of a sculpture or a base but rather must completely form the work before the dough sets.

Second, existing doughs are dense and heavy because of the presence of a significant amount of water by weight. This increases transportation costs of the compounds as well as requires shelves with sufficient strength to bear the weight of the dough. In addition, it hinders artists from molding large sculptures and artwork because it is difficult to transport them. Instead, such works must be formed at the location at which they will be displayed. However, this may be inconvenient because of space constraints or because it may be unappealing in public places.

Additionally, it is desirable to have modeling dough that is able to float in water. This allows children to play with the dough and the toys during a shower, in a bathtub or a pool. Moreover, it allows artists to create art in another medium such as water.

Finally, the presence of a significant amount of water in the compound is disadvantageous during the process of making the compound itself. Specifically, one of the steps for forming the modeling compounds requires that the clay is air dried to form the final product. However, air drying causes water loss which results in a non-uniform mixture with air pockets. This is undesirable because the product shrinks and more materials and mixture is needed to compensate for the loss of volume during production. In fact, it is extremely difficult to predict how much shrinking will occur and thus difficult to plan to achieve a pre-determined dimension.

Furthermore, the air pockets create a non-uniform mixture. This not only reduces the plasticity of the dough but also degrades the desired soft, tactile feel of the compound. Consequently, it is more difficult for children to mold the dough and renders the dough useless as a toy. Additionally, artists also find it difficult to work with the more rough doughs and prefer to use softer and more tactile dough as armatures for sculptures and other artwork.

One object and advantage of the present invention is to provide modeling dough that contains an insignificant amount of water.

It is another object and advantage of the present invention to provide modeling dough that is less dense and consequently light.

It is still another object and advantage of the present invention to provide modeling dough that floats in water.

It is yet another an object and advantage of the present invention to provide a modeling dough that is highly moldable.

It is further an object and advantage of the present invention to provide modeling dough that is a uniform mixture.

It is an additional object and advantage of the present invention to provide modeling dough that exhibits a soft, tactile feel.

It is still further an object and advantage of the present invention to provide modeling dough that has low shrinkage during production of the final product.

The above and other objects, advantages, and features of the present invention will become readily appreciated and understood from consideration of the following detailed description of the preferred embodiments of the present invention.

### SUMMARY OF THE INVENTION

In accordance with the foregoing objects, in the preferred exemplary embodiment, the present invention comprises polyvinyl chloride resin, plasticizers, stabilizer, microspheres and a thixotropic agent. Additionally, the preferred exemplary embodiment comprises only 0.3% water or no water at all.

The preferred exemplary embodiment of the present invention provides several advantages over existing modeling compounds. The present invention comprises little or no water by weight and is less dense than existing natural or man-made clays and modeling compounds. This is advantageous because the modeling dough can be used in water as a floating toy. Additionally, the decreased density results in light dough which can be easily transported. For example, transportation costs are significantly reduced during distribution of the dough. Moreover, artwork utilizing the present invention can be easily may be formed and moved more easily than existing heavy doughs.

In addition, since the present invention comprises little or no water, it may be dried in a vacuum during production. This significantly increases the uniformity of the dough and at least substantially diminishes the shrinkage and loss of soft, tactile feel problems which are found in traditional modeling compounds that are air dried.

Finally, the preferred embodiment of the present invention retains excellent plasticity and malleability even under dry and prolonged use conditions, which conditions degrade traditional modeling doughs. Moreover, the present invention requires less stringent storage procedures and exhibits an increased shelf life.

### DETAILED DESCRIPTION OF THE INVENTION

While various embodiments of the present invention are discussed in detail below, it should be appreciated that the present invention provides inventive concepts that can be embodied in wide variety of specific contexts. The specific embodiments discussed are merely illustrative of specific ways to make and use the invention and do not limit the scope of the invention.

The preferred exemplary embodiment of the present invention comprises 48.8% polyvinyl chloride resin, 20.7% primary plasticizer, 1.2% secondary plasticizer, 1.2% stabilizer, 26.4% microspheres and 1.8% thixotropic agent. Each constituent of the preferred embodiment of the present invention is discussed below. The present invention comprises 0.3% or less of water. In the preferred exemplary embodiment, the water is derived from the environment. Although the composition of the preferred exemplary embodiment of the modeling dough is disclosed, it should be appreciated by those of ordinary skill in the art that the exact composition may vary without deviating from the present invention. As an example, the present invention may comprise 40-60% resin, 20-25% primary plasticizer, 1-3% secondary plasticizer, 1-2% stabilizer, 15-25% microspheres and 1-3% thixotropic agent. In fact, during production of the present invention as well as existing modeling compounds, it is well known to those in the art that the composition of each constituent is adjusted in comparison to the others in order to obtain desired plasticity, density, feel and/or appearance of the product. For example, it is well known in the art that if a greater amount of resin is utilized during production, a greater amount of plasticizer or other compound such as gellant is needed to increase the thixotropy of the modeling dough. The exact composition of the modeling compound or dough need not be limited to the specific values disclosed in the preferred exemplary embodiment.

The preferred exemplary embodiment comprises polyvinyl chloride as its resin. The resin is a chemically inert powder which binds the compound. Therefore, the polyvinyl chloride prevents the final compound from crumbling or falling apart. Although polyvinyl chloride is used in the preferred exemplary embodiment of the present invention, it should be appreciated by one of ordinary skill in the art that other resins may also be utilized in the modeling dough. Additionally, although the percentage of polyvinyl chloride is specified it should be appreciated by those of ordinary skill in the art that the composition of the resin may vary upon the desired characteristics of the modeling dough.

In addition, the preferred exemplary embodiment comprises a primary plasticizer which makes the resin more flexible. In the preferred exemplary embodiment of the present invention, any monomeric or polymeric plasticizer may be utilized. It will be appreciated by those of ordinary skill in the art that the selection of the primary plasticizer will affect the fusion temperature and the gelation of the modeling dough. The primary plasticizer makes the resin more flexible and thus affects the properties of the finished modeling dough.

Moreover, the preferred exemplary embodiment of the present invention comprises a secondary plasticizer in small amounts for heat stabilization. It should be appreciated by those skilled in the art that the present invention need not include the secondary plasticizer.

Furthermore, the preferred exemplary embodiment of the present invention comprises a stabilizer which makes the resin tolerant to high temperatures. This is important because high temperatures which may be present during production or storage of the modeling dough degrade the stability of the resin. The stabilizers enhance the thermal stability of the resin so that the modeling dough will retain its consistency, plasticity and other characteristics during higher temperatures and for long periods of time. In the preferred exemplary embodiments of the present invention, heat stabilizers comprise metal ions which complex with hydrochloric acid (HCL). As known to those of ordinary skill in the art these may include but are not limited to Ba/Zn, Ca/Zn, Ba/Cd/Zn, Sn, and epoxidized soybean oil. However, it should be noted that other heat stabilizers may also be utilized in the present invention.

The preferred exemplary embodiment of the present invention further comprises microspheres which act as a filler material and lower the density of the modeling compound. In the preferred exemplary embodiment, a microsphere comprises a dry expanded polymer shell which encapsulates a gas. It should be appreciated by those of ordinary skill in the art that various types of microspheres such as glass, plastic, empty or filled microspheres may be utilized. However, it should be noted that the physical properties of the modeling compound can vary based on the type of microsphere used. For example, using microspheres with large diameters might result in a grainy modeling compound whereas using microspheres with very small diameters might increase the density of the compound.

Finally, the preferred exemplary embodiment of the present invention comprises a rheology modifier such as a thixotropic agent which converts the product to a putty-like, malleable substance. The thixotropic agent is an organic filler which is added to the resin to further transform the substance into a putty-like substance which can be manipulated at room temperature and still retain its shape at temperatures as high as 275 degrees F.

The process for forming the preferred exemplary embodiment of the present invention comprises mixing the polyvinyl chloride, the primary plasticizer, the secondary plasticizer and the stabilizer in a double arm sigma blade mixer. It should be appreciated by those of ordinary skill in the art that other types of mixers may also be utilized. Additionally, the mixture is subjected to a vacuum for 5 minutes at 24 inches of mercury. The compound is mixed under vacuum because it results in more uniform dough with minimal air pockets.

Thereafter, the microspheres are added utilizing a pump device recommended by the supplier for the particular microspheres to minimize dust and reduce the potential for a dust explosion. It is important to achieve optimal uniformity during the previous stage because over mixing after the addition of microspheres must be avoided. Over mixing can degrade the micorspheres and generate excessive heat which degrades the final product and shortens its shelf life. Finally, the rheology modifier and more particularly the thixotropic agent is added to give the clay its final consistency.

To set the dough after a user has formed his or her object, the dough is baked. Theoretically, during the baking process in the preferred exemplary embodiment, the primary plasticizer wets the resin and then diffuses into the resin particles at 122 degrees F. The mixture is further heated from 302 degrees F. to 338 degrees F. at which point the particles start to swell. The mixture is heated to a gelation temperature, the maximum temperature at which the swelling occurs. The mixture is heated further to knit the polymer particles. In the preferred embodiment of the invention, for the sake of baking safety, the clay is baked at 275 degrees F. for 15 minutes per (¼) inch thickness of the clay. In the preferred embodiment of the present invention, if the user's object comprises portions of varying thicknesses, the relatively thin portions may be covered with aluminum foil to prevent overheating or burning. However, it should be appreciated by those of ordinary skill in the art that a different temperature and time for baking may be used to achieve other desired properties in the final dough. Additionally, it should be appreciated that any covering which prevents the dough from overheating or burning may also be utilized instead of the aluminum foil.

The specific embodiments discussed in the detailed description are merely illustrative of specific ways to make and use the invention, and do not limit the scope of the invention.

1. A modeling compound comprising, in combination,
resin;
primary plasticizer;
stabilizer;
microspheres; and
rheology modifier.

2. A modeling compound as in claim 1 where said resin comprises polyvinyl chloride.

3. A modeling compound as in claim 1 where said primary plasticizer comprises a monomeric plasticizer.

4. A modeling compound as in claim 1 where said primary plasticizer comprises a polymeric plasticizer.

5. A modeling compound as in claim 1 where said stabilizer comprises metal ion which complexes with HCL.

6. A modeling compound as in claim 1 where said microspheres comprise dry expanded polymer shells which encapsulate a gas.

7. A modeling compound as in claim 1 where said rheology modifier comprises a thixotropic agent.

8. A modeling compound as in claim 1 further comprising a secondary plasticizer.

9. A modeling compound comprising, in combination,
40%-60% polyvinyl chloride by weight of the compound;
20%-25% primary plasticizer by weight of the compound;
1%-3% secondary plasticizer by weight of the compound;
1%-2% stabilizer by weight of the compound;
15%-25% microspheres by weight of the compound; and
1%-3% thixotropic agent by weight of the compound.

10. A modeling compound as in claim 9 where said polyvinyl chloride comprises 48.8% by weight of the compound.

11. A modeling compound as in claim 9 where said primary plasticizer comprises a monomeric plasticizer.

12. A modeling compound as in claim 9 where said primary plasticizer comprises a polymeric plasticizer.

13. A modeling compound as in claim 9 where said primary plasticizer comprises 20.7% by weight of the compound.

14. A modeling compound as in claim 9 where said secondary plasticizer comprises 1.2% by weight of the compound.

15. A modeling compound as in claim 9 where said stabilizer comprises metal ion which complexes with HCL.

16. A modeling compound as in claim 9 where said stabilizer comprises 1.2% by weight of the compound.

17. A modeling compound as in claim 9 where said microspheres comprise dry expanded polymer shells which encapsulate a gas.

18. A modeling compound as in claim 9 where said microspheres comprise 26.4% by weight of the compound.

19. A modeling compound as in claim 9 where said thixotropic agent comprises 1.8% by weight of the compound.

20. A process for forming a modeling compound, comprising,
mixing a resin, a primary plasticizer, a secondary plasticizer and a stabilizer to a smooth liquid consistency to create a mixture;
adding and mixing microspheres to said mixture after said smooth liquid consistency is achieved; and
adding rheology modifier after said microspheres are mixed with said mixture.

21. A process for forming a modeling compound as in claim 20 where said resin comprises polyvinyl chloride.

22. A process for forming a modeling compound as in claim 20 where said primary plasticizer comprises a monomeric plasticizer.

23. A process for forming a modeling compound as in claim 20 where said primary plasticizer comprises a polymeric plasticizer.

24. A process for forming a modeling compound as in claim 20 where said stabilizer comprises metal ions which complex with HCL.

25. A process for forming a modeling compound as in claim 20 where said rheology modifier comprises a thixotropic agent.

26. A process for forming a modeling compound as in claim 21 where said polyvinyl chloride comprises 40%-60% by weight of the compound.

27. A process for forming a modeling compound as in claim 20 where said primary plasticizer comprises 20%-25% by weight of the compound.

28. A process for forming a modeling compound as in claim 20 where said secondary plasticizer comprises 1%-3% by weight of the compound.

29. A process for forming a modeling compound as in claim 24 where said stabilizer comprises 1%-2% by weight of the compound.

30. A process for forming a modeling compound as in claim 25 where said thixotropic agent comprises 1%-3% by weight of the compound.
